(19) United States
(12) Patent Application Publication
(10) Pub. No.: US 2025/0200887 A1
(43) Pub. Date: Jun. 19, 2025

(54) SYSTEM AND METHOD FOR TRIGGERING DATA TRANSFER USING PROGRESS TRACKING

(71) Applicant: AI CLEARING INC., Austin, TX (US)

(72) Inventors: Michal MAZUR, Warsaw (PL); Adam WISNIEWSKI, Warsaw (PL); Jakub LUKASZEWICZ, Warsaw (PL); Dariusz CIESLA, Warsaw (PL)

(21) Appl. No.: 18/866,973

(22) PCT Filed: May 19, 2023
(86) PCT No.: PCT/IB2023/055188

§ 371 Date: Nov. 18, 2024

(30) Foreign Application Priority Data
May 19, 2022 (EP) 22174347.9

(51) Int. Cl. G06T 17/05; G06T 7/73; G06V 10/62; G06V 10/764; G06V 10/77; G06V 10/82; G06V 20/17

(52) U.S. Cl. CPC G06T 17/05; G06T 7/75; G06V 10/82; G06V 20/17; G06T 2207/10032; G06T 2207/20084; G06V 10/62; G06V 10/764; G06V 10/7715

(57) ABSTRACT

A method and a system are disclosed. The system and method for analysing progress on at least one construction site, wherein the system comprises at least one data processing component configured to process at least one input orthophoto map of an area. The system comprises at least one feature determining component configured to determine feature data of the at least one input orthophoto map. The system comprises at least one analysing component configured to initiate at least one communication based on at least the determined feature data.

The present invention relates to the field of image analysis and particularly to the field of analysis of aerial images. The present invention further relates to automatically analysing progress of construction sites.

The concept of analysing areas by means of aerial images is generally known. It is evolving in particular since the unmanned aerial vehicles have become broadly available. Aerial images can for example be used for analysing construction sites, e.g., the progress of the work can be monitored.

Classically, the progress of construction sites as well as an adherence to plans, e.g., in terms of precise positions of structures etc, is monitored by land surveyors. Depending on the size of the construction site, the monitoring can only be performed at crucial points or at random, already due to the distances to cover, e.g., in case of highway construction sites. Further, an important part of construction project management is schedule monitoring

Apart from the problem that in some cases, not the whole site can be analysed, it is also hard to assess the accuracy of the survey generated by the surveyor unless a second survey is performed, requiring more resources. Since survey results on construction sites are inter alia used as condition for authorizing payments, there may be a need to be able to have a revisable survey.

The analysis of the sites may be performed by cameras mounted to aerial vehicles, such as airplanes or drones. However, in this case, the resulting images need to be processed correspondingly. The further processing can be performed manually, or with computer-support.

U.S. Pat. No. 10,339,663 B2 discloses systems and methods for generating georeferenced information with respect to aerial images. In particular, in one or more embodiments, systems and methods generate georeference information relating to aerial images captured without ground control points based on existing aerial images. For example, systems and methods can access a new set of aerial images without ground control points and utilize existing aerial images containing ground control points to generate a georeferenced representation corresponding to the features of the new set of aerial images. Similarly, systems and methods can access a new image without ground control points and utilize an existing georeferenced orthomap to produce a georeferenced orthomap corresponding to the features of the new image. One or more embodiments of the disclosed systems and methods permit users to obtain georeference information related to new images without the need to place ground control points or collect additional georeferenced information.

U.S. Pat. No. 10,593,108 B2 discloses systems and methods for more efficiently and quickly utilizing digital aerial images to generate models of a site. In particular, in one or more embodiments, the disclosed systems and methods capture a plurality of digital aerial images of a site. Moreover, the disclosed systems and methods can cluster the plurality of digital aerial images based on a variety of factors, such as visual contents, capture position, or capture time of the digital aerial images. Moreover, the disclosed systems and methods can analyse the clusters independently (i.e., in parallel) to generate cluster models. Further, the disclosed systems and methods can merge the cluster models to generate a model of the site.

U.S. Pat. No. 9,389,084 B2 is directed toward systems and methods for identifying changes to a target site based on aerial images of the target site. For example, systems and methods described herein generate representations of the target site based on aerial photographs provided by an unmanned aerial vehicle. In one or more embodiments, systems and method described herein identify differences between the generated representations in order to detect changes that have occurred at the target site.

Sigalov, K.; Ye, X.; König, M.; Hagedorn, P.; Blum, F.; Severin, B.; Hettmer, M.; Hückinghaus, P.; Wölkerling, J.; Groß, D. Automated Payment and Contract Management in the Construction Industry by Integrating Building Information Modelling and Blockchain-Based Smart Contracts. Appl. Sci. 2021, 11, 7653. https://doi.org/10.3390/app11167653 describes the framework, referred to as BIMcontracts, the container-based data exchange, and the digital contract management workflow. It discusses the industry-specific requirements for blockchain and data storage and explains which technical and software architectural decisions were made.

The present invention alleviates the shortcomings of the prior art by disclosing a system and a method to automatically determine the execution of a smart contract based on the aerial images.

An important part of construction project management is progress tracking, schedule monitoring, stage approvals and ultimately payment release. Currently, the above are manual, labour-intensive processes prone to error or manipulation. Stage approvals are mainly based on field team reports. However, with the increasing adoption of aerial vehicles such as drones, for data acquisition, AI methods for its analysis and reporting are becoming available. With automated progress tracking, stage approval and payment releases can be automated.

The core of the invention is to use automated progress tracking provided by artificial intelligent solutions to enable automated data transfer. The data transfer may be based on contractual terms, schedule, tracked progress.

A data processing component may check the progress of the work on the construction site, compare it with schedules and after verifying contractual terms will trigger the data transfer. For example, on a road construction project a main contractor would like to use the system or the method to automatically check the work of a subcontractor who is responsible for the tarmac/asphalt layer of the road. The subcontractor is supposed to build a 1000 sq. m. layer of asphalt within a month. The contract includes a penalty for each day of delay. An analysing component may automatically check the progress of the asphalt construction at the end of the contractual time, revealing the progress of 90%. In this embodiment if a pre-determined condition was 100%, the data transfer may not be triggered, further in some embodiments the subcontractor may automatically get a notification on a subcontractor device linked to the system about the progress and/or failure to deliver works.

In some embodiments a feature determining component may perform a periodic processing of an input orthophoto map to determine feature data. For example, the progress again 3 days later confirming that the works were completed. This period may be a pre-determined time interval, given as an input by a node, wherein the node can be a subcontractor use device. The pre-determined time interval may also be defined as a default by the node.

In a first embodiment, a system is disclosed. The system for analysing progress on at least one construction site, wherein the system comprises at least one data processing component configured to process at least one input orthophoto map of an area. The system comprises at least one feature determining component configured to determine feature data of the at least one input orthophoto map. The system comprises at least one analysing component configured to initiate at least one communication based on at least the determined feature data.

The term “feature” is intended to refer to an object in the area. However, “feature” may refer only to objects of interest, i.e., objects that are to be detected. For example, plain ground may not need to be detected or further classified. Objects that are no objects of interest may however be detected, e.g., as “background”. The features may correspond to parts. The term “part” may to refer to a part of the area corresponding to a feature or a portion thereof, e.g., when only a portion of a feature is within the area, or when only a section of the area is processed or photographed, which section only comprises a portion of a feature. The term “part” may also refer to a portion of an orthophoto map or a digital surface model, which portion corresponds to a feature/object in the area.

The person skilled in the art will easily understand that the feature data is the data relating to the features of the area, such as on a construction site an embarkment might be a feature and the volume of the embarkment might be the feature data.

The term “volume” is intended to refer to a solid, i.e., to a three-dimensional body, in other words a shape. A volume corresponding to a feature may be a volume approximating a geometry of the feature. In case that the object is an excavation, depression, hole or the like, the volume may thus also be a shape between a surface of the feature and the former surface, e.g., a ground surface.

The orthophoto map may also be referred to as orthomosaic or orthophoto. The orthophoto map may be generated based on one or more aerial images by means of photogrammetry. In other words, the orthophoto map may be generated by orthorectifying the one or more aerial images.

In an embodiment the data processing component is configured to provide the input orthophoto map of the area. In such embodiments the data processing component may be configured to communicated with an imaging component, such as an aerial device. The data processing component in some embodiments may be integrated with the imaging component.

In some embodiments the data processing component may be configured to generate at least one plurality of polygon(s) based on the input orthophoto map. In the following, the term “polygon(s)” will be used together with the plural form of a verb for reasons of clarity and conciseness. However, these statements are intended to also cover at least one polygon. In this disclosure, the term “polygon” is intended to refer to a geometric shape comprising n vertexes and n edges wherein the edges only intersect at the vertexes.

The person skilled in the art will easily understand that the polygon(s) which each approximate a part of the input orthophoto map (O) may in other words be linear ring(s) or closed polygonal chain(s), and that the polygon(s) may be indicated for example by one or more triangles forming a polygon. Thus, the polygon(s) may for example be described as at least one or a plurality of neighbouring triangles per polygon.

Whenever coordinates and/or elevation coordinates are used within this disclosure, the x-, y- and/or z-coordinates or directions are implied, the at least one elevation coordinate (such as the z-direction may be vertical), in other words orthogonal to a ground surface. The x- and y-directions may be orthogonal to each other and to the z-direction, i.e., they may be horizontal directions. The coordinates may form a Cartesian coordinate system.

In some embodiments the data processing component can further be configured to generate at least one plurality of polygon(s) based on the input orthophoto map. The data processing component and/or the system may be configured to generate the polygon(s), each polygon approximating a part of the input orthophoto map.

In some embodiments the analysing component may be integrated with the data processing component such that the data processing component comprises the analysing component. It is not to be excluded that the data processing component and the analysing component can be independent components and/or computing units which can be integrated to one in some embodiments and in others can be used as separate components. In embodiments where the two components i.e., the data processing component and the analysing component are independent they may still communicate via any known communication protocols and transfer data.

In some embodiments the processing component can be configured to generate the polygon(s) based on the input orthophoto map, each polygon approximating a part of the input orthophoto map. The part of the input orthophoto map may be a portion of the input orthophoto map within the corresponding polygon.

In some embodiments the analysing component can be configured to determine the feature data by projecting the polygon(s) on the input orthophoto map. The feature data may be geo-referenced feature data. The feature data may be designed object. In some embodiments the feature data can comprise a feature map, where the feature map may be a multi-dimensional matrix of neurons. In such embodiments the feature determining component may be configured with deep learning techniques which can be configured to receive an input feature data and generate at least one block of an output/determined feature data. In such embodiments the analysing component may be equipped with a classifier which can then classify the feature data into at least one class.

In some embodiments the feature determining component may be configured for processing at least elevation coordinates of the at least some polygon(s) projected to the feature data. In such embodiments the feature determining component may be determining geographical positions of the vertexes of each polygon, such as geographical coordinates of said vertexes. For example, the feature determining component may be configured for extracting the geographical positions of the vertexes from the input orthophoto map.

In some embodiments the feature determining component may further be configured for processing at least the input orthophoto map using the feature data. In such embodiments the feature data used may be the output/determined feature data which may be generated by the feature determining component.

In some embodiments the feature determining component may be configured for determining the features of the input orthophoto map by means of at least one convolutional neural network. In some embodiments the feature data comprises at least one coordinate-based representation of at least one surface in 2D and/or 3D.

In some feature determining component is further configured to determine a change in feature over a pre-determined time interval in the at least two input orthophoto maps. In such embodiments the time interval can be inputted into the feature determining component externally, such as via an external user device.

In some embodiments the change in feature can comprises absence of a coordinate and/or pixel and/or polygon, addition of at least one coordinate and/or pixel and/or polygon on the input orthophoto map. In some embodiments the change in feature can comprise at least one addition and/or subtraction of dimension and/or layer in the feature data.

In some embodiments the analysing component can be configured for determining changes between the at least two input orthophoto map allowing progress tracking/detecting progress/changes, thus generating first polygon(s). In some embodiments the analysing component is configured for comparing at least some of the first polygon(s). In some embodiments the analysing component can be configured for processing the change in features.

In some embodiments the analysing component can be configured for assigning portions to the feature data and/or the orthophoto map comprising same classes to groups. In such embodiments the analysing component can comprise a machine learning component. The analysing component can be trained on an existing knowledgebase of orthophoto maps to predict at least one class in the feature data. In such embodiments the analysing component can comprise reinforcement learning techniques.

In some embodiments assigning the portions comprising same classes to groups can comprise assigning connected portions comprising same classes to groups. In such embodiments, each group can correspond to a part of the orthophoto map.

In some embodiments the analysing component can further configured to determine at least one feature difference between the at least two assigned classes of the orthophoto map and/or feature data taken at least two different times. This feature difference can comprise the change in feature. It may be noted that the change in feature and feature difference can be same or similar when the class comprise less than two elements.

In some embodiments the analysing component can be configured to determine the at least one feature difference between the at least one assigned class of the orthophoto map and/or feature data and at least one pre-determined class. For example, if there is an embarkment on a road construction project, the feature difference can comprise the difference in amount of asphalt laid at two different times.

In some embodiments the analysing component can be configured to automatically determine at least one stage based on the determined feature difference, for example the stage of road construction project.

In some embodiments the analysing component can be configured to automatically determine the at least one stage based on the determined change in feature, for example absence and/or presence of asphalt in the road construction project.

In some embodiments the analysing component comprises at least one schedule data based on the at least one stage. For construction projects, the stage can be automatically determined by the analysing component as pre-construction stage, procurement stage, construction stage and post-construction stage. The analysing component may be trained to determine the at least one stage, this can be done by training the analysing component on the at least feature data and/or change in feature and/or feature difference.

In some embodiments the analysing component can be configured to deploy at least one transaction protocol, such as a smart contract. The transaction protocol can be based on a schedule data. The schedule data can be extracted by the analysing component from the at least one node. The schedule data may comprise one or more time tags, time tag may comprise a start date and/or a end date for example associated with each stage.

In some embodiments the analysing component can be configured to generate at least one schedule model. In some embodiments the schedule model may be inputted to the analysing component. The schedule model may be based on at least the schedule data.

In some embodiments the schedule model can comprise at least one parameter based on the stage. Such a parameter may be a numerical score associated with each stage of a project, for example, the road construction project.

In some embodiments the schedule model can be configured to be generated based on the feature data.

In some embodiments the schedule model may be configured to be based on the determined/output feature data.

In some embodiments the transaction protocol may be configured to be executed based on the schedule model.

In some embodiments the analysing component may be configured for enabling the communication between at least two nodes based on the schedule model.

In some embodiments wherein the analysing component may be configured for enabling the communication between the two nodes when a pre-determined condition is met.

In some embodiments the pre-determined condition comprises a pre-determined stage.

In some embodiments communication comprises at least one data transfer.

In a second embodiment a method is disclosed. The method comprising processing at least one input orthophoto map of an area, determining feature data of at least one input orthophoto map, and initiating at least one communication based on at least the determined feature data.

The system may be configured for performing the method according to any of the preceding method embodiments.

In a third embodiment, a computer program product is disclosed.

A computer program product may comprise instructions which, when the program is executed by a computer, cause the computer to carry out the steps of the above-disclosed method.

Another computer program product may comprise instructions which, when the program is executed by a data processing component, cause the data processing component to carry out the steps for which the data processing component is configured.

The following embodiments also form part of the invention.

### System Embodiments

Below, embodiments of a system will be discussed. The system embodiments are abbreviated by the letter “S” followed by a number. Whenever reference is herein made to the “system embodiments”, these embodiments are meant.

S1. A system for analysing progress on at least one construction site, wherein the system comprising:
at least one data processing component configured to process at least one input orthophoto map of an area,
at least one feature determining component configured to determine feature data of the at least one input orthophoto map,
at least one analysing component configured to initiate at least one communication based on at least the determined feature data.

S2. The system according to the preceding embodiment wherein the data processing component is configured to provide the input orthophoto map of the area.

S3. The system according to any of the preceding embodiments wherein the data processing component is further configured to generate at least one plurality of polygon(s) based on the input orthophoto map.

S4. The system according to the preceding embodiment wherein the data processing component is configured to generate the polygon(s), each polygon approximating a part of the input orthophoto map.

S5. The system according to any of the preceding embodiments wherein the data processing component comprises the analysing component.

S6. The system according to any of the preceding embodiments wherein data processing component is configured to generate the polygon(s) based on the input orthophoto map, each polygon approximating a part of the input orthophoto map.

S7. The system according to any of the preceding embodiments wherein the analysing component is configured to determine the feature data by projecting the polygon(s) on the input orthophoto map.

S8. The system according to any of the preceding embodiments wherein the feature determining component is configured for processing at least elevation coordinates of the at least some polygon(s) projected to the feature data.

S9. The system according to any of the preceding embodiments wherein the feature determining component is configured for processing at least the input orthophoto map using the feature data.

S10. The system according to any of the preceding embodiments wherein the system particularly the feature determining component is configured for determining the features of the input orthophoto map by means of at least one convolutional neural network.

S11. The system according to any of the preceding embodiments wherein the feature data comprises at least one coordinate-based representation of at least one surface in 2D or 3D.

S12. The system according to any of the preceding embodiments wherein the feature determining component is further configured to determine a change in feature over a pre-determined time interval in the at least two input orthophoto maps.

S13. The system according to the preceding embodiment wherein the change in feature comprises absence of a coordinate and/or pixel and/or polygon, addition of at least one coordinate and/or pixel and/or polygon.

S14. The system according to any of the preceding embodiments wherein the analysing component is configured for determining changes between the at least two input orthophoto map allowing progress tracking/detecting progress/changes, thus generating first polygon(s).

S15. The system according to any of the two preceding embodiments the analysing component, is configured for comparing at least some of the first polygon(s).

S16. The system according to any of the preceding embodiments and features of S12 wherein the analysing component, is configured for processing the change in features.

S17. The system according to the preceding embodiment, wherein the analysing component is configured for assigning portions to the feature data and/or the orthophoto map comprising same classes to groups.

S18. The system according to the preceding embodiment, wherein assigning the portions comprising same classes to groups comprises assigning connected portions comprising same classes to groups.

S19. The system according to any of the two preceding embodiments, wherein each group corresponds to a part of the orthophoto map.

S20. The system according to any of the preceding embodiments wherein the analysing component is further configured to determine at least one feature difference between the at least two assigned classes of the orthophoto map and/or feature data taken at least two different times.

S21. The system according to any of the preceding embodiments wherein the system, particularly the analysing component is configured to determine the at least one feature difference between the at least one assigned class of the orthophoto map and/or feature data and at least one pre-determined class.

S22. The system according to any of the preceding embodiments wherein the system, particularly the analysing component is configured to determine at least one stage based on the determined feature difference.

S23. The system according to any of the preceding embodiments and feature of S12 wherein the system, particularly the analysing component is further configured to determine the at least one stage based on the determined change in feature.

S24. The system according to any of the preceding embodiments wherein the analysing component comprises at least one schedule data based on the at least one stage.

S25. The system according to any of the preceding embodiments wherein the analysing component is configured to deploy at least one transaction protocol, such as a smart contract.

S26. The system according to any of the preceding two embodiments wherein the transaction protocol is configured to be based on schedule data.

S27. The system according to any of the preceding embodiments wherein the system, particularly the analysing component is configured to generate at least one schedule model.

S28. The system according to any of the preceding embodiments and features of S26 wherein the schedule model comprises at least one parameter based on the stage.

S29. The system according to any of the preceding embodiments wherein the system comprises the schedule model.

S30. The system according to any of the preceding embodiments wherein the schedule model is configured to be generated based on schedule data.

S31. The system according to any of the preceding embodiments wherein the schedule model is configured to be generated based on the feature data.

S32. The system according to any of the preceding embodiments wherein the schedule model is configured to be based on the determined feature data.

S33. The system according to any of the preceding embodiments and features of S29 wherein the transaction protocol is configured to be executed based on the schedule model.

S34. The system according to any of the preceding embodiments wherein the analysing component is configured for enabling the communication between at least two nodes based on the schedule model.

S35. The system according to any of the preceding embodiments wherein the analysing component is configured for enabling the communication between the two nodes when a pre-determined condition is met.

S36. The system according to the preceding embodiment wherein the pre-determined condition comprises a pre-determined stage.

S37. The system according to any of the preceding three embodiments wherein the communication comprises at least one data transfer.

S38. The system according to any of the preceding system embodiments wherein the system is a system configured for analysis of aerial images.

S39. The system according to any of the preceding system embodiments wherein the data-processing component is configured for receiving at least one of image data and elevation data from an aerial vehicle and/or a satellite.

S40. The system according to the preceding embodiment wherein the aerial vehicle is an unmanned aerial vehicle.

S41. The system according to any of the preceding embodiments wherein the system comprises the aerial vehicle, preferably the unmanned aerial vehicle, and wherein the aerial vehicle, preferably the unmanned aerial vehicle, is configured for generating at least one of the image data and the elevation data.

S42. The system according to any of the preceding embodiments wherein the area comprises a construction site.

S43. The system according to any of the preceding embodiments wherein the orthophoto map comprises RGB data.

S44. The system according to any of the preceding embodiments wherein the orthophoto map comprises infrared data.

S45. The system according to any of the preceding embodiments wherein the point cloud is generated based on at least LIDAR-measurement.

S46. The system according to the preceding embodiment wherein the LIDAR-measurement is performed by a drone comprising a LIDAR-sensor.

### Method Embodiments

Below, embodiments of a method will be discussed. The method embodiments are abbreviated by the letter “M” followed by a number. Whenever reference is herein made to the “method embodiments”, these embodiments are meant.

M1. A method, comprising:
processing at least one input orthophoto map of an area,
determining feature data of at least one input orthophoto map,
initiating at least one communication based on at least the determined feature data.

M2. The method according to any of the preceding embodiments, comprising providing the input orthophoto map of the area.

M3. The method according to any of the preceding embodiments, comprising generating at least one plurality of polygon(s) based on the input orthophoto map.

M4. The method according to any of the preceding embodiments, comprising generating the polygon(s) each polygon approximating a part of the input orthophoto map.

M5. The method according to any of the preceding embodiments, comprising providing the data processing component with the analysing component.

M6. The method according to any of the preceding embodiments, comprising generating the polygon(s) based on the input orthophoto map, each polygon approximating a part of the input orthophoto map.

M7. The method according to any of the preceding embodiments, comprising determining the feature data by projecting the polygon(s) on the input orthophoto map.

M8. The method according to any of the preceding embodiments, comprising processing at least elevation coordinates of the at least some polygon(s) projected to the feature data.

M9. The method according to any of the preceding embodiments, comprising processing at least the input orthophoto map using the feature data.

M10. The method according to any of the preceding embodiments, comprising determining the features of the input orthophoto map by means of at least one convolutional neural network.

M11. The method according to any of the preceding embodiments, comprising providing the feature data with at least one coordinate-based representation of at least one surface in 2D or 3D.

M12. The method according to any of the preceding embodiments, comprising determining a change in feature over a pre-determined time interval in the at least two input orthophoto maps.

M13. The method according to any of the preceding embodiments, wherein the change in feature to comprises absence of a coordinate and/or pixel and/or polygon, addition of at least one coordinate and/or pixel and/or polygon.

M14. The method according to any of the preceding embodiments comprising determining changes between the at least two input orthophoto map allowing progress tracking/detecting progress/changes, thus generating first polygon(s).

M15. The method according to any of the preceding embodiments comprising comparing at least some of the polygon(s).

M16. The method according to any of the preceding embodiments comprising processing the change in features.

M17. The method according to any of the preceding embodiments comprising assigning portions to the feature data and/or the orthophoto map comprising same classes to groups.

M18. The method according to any of the preceding embodiments comprising assigning the portions comprising same classes to groups comprises assigning connected portions comprising same classes to groups.

M19. The method according to any of the preceding two embodiments wherein each group corresponds to a part of the orthophoto map.

M20. The method according to any of the preceding embodiments comprising determining at least one feature difference between the at least two assigned classes of the orthophoto map and/or feature data taken at least two different times.

M21. The method according to any of the preceding embodiments comprising determining the at least one feature difference between the at least one assigned class of the orthophoto map and/or feature data and at least one pre-determined class.

M22. The method according to any of the preceding embodiments comprising determining at least one stage based on the determined feature difference.

M23. The method according to any of the preceding embodiments comprising determining the at least one stage based on the determined change in feature.

M24. The method according to any of the preceding embodiments comprising providing at least one schedule data based on the at least one stage.

M25. The method according to any of the preceding embodiments comprising deploying at least one transaction protocol, such as a smart contract.

M26. The method according to any of the preceding embodiments comprising configuring the transaction protocol to be based on the scheduled data.

M27. The method according to any of the preceding embodiments comprising generating at least one schedule model.

M28. The method according to any of the preceding embodiments comprising providing the schedule model at least one parameter based on the stage.

M29. The method according to any of the preceding embodiments comprising providing the schedule model.

M30. The method according to any of the preceding embodiments comprising generating the schedule model based on schedule data.

M31. The method according to any of the preceding embodiments comprising generating the schedule model based on the feature data.

M32. The method according to any of the preceding embodiments comprising schedule model to be based on the determined feature.

M33. The method according to any of the preceding embodiments comprising execution of the transaction protocol based on the schedule model.

M34. The method according to any of the preceding embodiments comprising enabling the communication between at least two nodes based on the schedule data.

M35. The method according to any of the preceding embodiments comprising enabling the communication between the two nodes when a pre-determined condition is met.

M36. The method according to any of the preceding embodiments comprising providing the pre-determine condition based on a pre-determined stage.

M37. The method according to any of the preceding embodiments wherein the step of enabling communication comprises enabling at least one data transfer.

S47. The system according to any of the preceding system embodiments wherein the system is configured to perform any of the preceding method steps according to any of the preceding method embodiments.

### Computer Program Product Embodiments

Below, embodiments of a computer program product will be discussed. These embodiments are abbreviated by the letter “C” followed by a number. Whenever reference is herein made to the “computer program product embodiments”, these embodiments are meant.

C1. A computer program product comprising instructions which, when the program is executed by a computer, cause the computer to carry out the steps of the method according to any of the method embodiments.

C2. A computer program product comprising instructions which, when the program is executed by a data processing component, cause the data processing component to perform the operations for which the data processing component is configured.

Exemplary features of the invention are further detailed in the figures and the below description of the figures.

### BRIEF DESCRIPTION OF THE FIGURES

FIG. 1a shows an unmanned aerial vehicle over a construction site.

FIG. 1b shows an orthophoto map and a digital elevation model of the construction site.

FIG. 2 shows classes assigned to features on the construction site.

FIG. 3 shows a view of polygons representing the feature data.

FIG. 4 shows reference surfaces of for the objects.

FIG. 5 shows volumes of the objects.

FIG. 6 shows a polygon.

FIG. 7 show embodiments of a method.

FIG. 8 shows a system configured for performing the method.

FIG. 9 shows an orthophoto map in different orientations.

FIG. 10-12 shows an orthophoto map in different orientations.

### DETAILED FIGURE DESCRIPTION

For the sake of clarity, some features may only be shown in some figures, and others may be omitted. However, also the omitted features may be present, and the shown and discussed features do not need to be present in all embodiments.

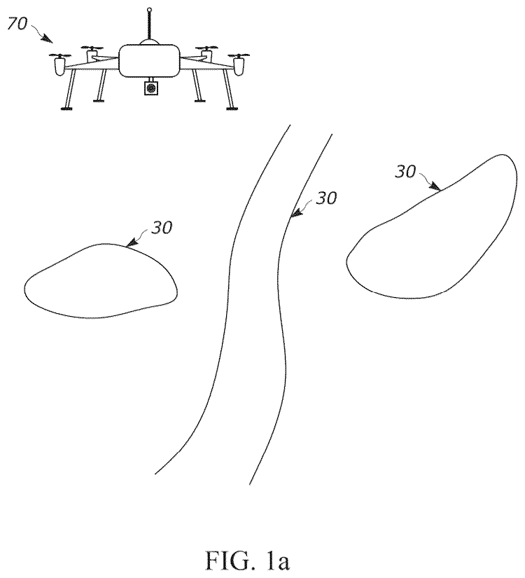

FIG. 1a shows an aerial vehicle flying over an area 10, such as a construction site. The aerial vehicle may be an unmanned aerial vehicle 70, which may also be referred to as drone. The aerial vehicle may comprise a camera for taking at least one image of the area. The aerial vehicle may further comprise a sensing device configured for sensing a height of the area, e.g. a distance sensor, an altitude sensor and a corresponding processing unit.

Based on the data generated by the aerial vehicle 70, an orthophoto map O and a digital elevation model DEM may be generated.

This is typically achieved by a photogrammetry process well known in the art. Background and application are for example discussed in Ahmadi, Farshid Farnood, and Ham id Ebadi: “An integrated photogrammetric and spatial database management system for producing fully structured data using aerial and remote sensing images.” Sensors (Basel, Switzerland) vol. 9,4 (2009): 2320-33. doi:10.3390/s90402320

For the photogrammetry process, e.g. the software Pix4Dmapper, available from Pix4D S.A., Prilly, Switzerland, can be used.

The aerial vehicle may comprise or be a multirotor drone, a fixed-wing drone and/or a vertical take-off and landing drone. The aerial vehicle may comprise an optical sensor for taking at least two images of the area. The aerial vehicle may further comprise a sensing device configured for sensing a height of the area, e.g. a distance sensor, an altitude sensor and a corresponding processing unit.

The aerial vehicle may also comprise components enabling a Real-Time Kinematic (RTK) and a Post-Processing Kinematic (PPK) technology. Both technologies may comprise receiving additional image data from satellites and a stationary ground station.

Further, FIG. 1a shows features in the area 10. The features may be parts 30 of the orthophoto map O and the digital elevation model. The features may for example comprise heaps of sand or other material, or sand. However, the feature may also comprise machinery, materials for construction such as concrete parts or pipes, or a feature that is under construction, such as a street, a building or infrastructure objects.

FIG. 1b shows an orthophoto map O generated by the at least one or a plurality of images of the area 10. The orthophoto map O may comprise RGB-data. However, the orthophoto map may also comprise different data, e.g. infrared data.

The area can comprise a construction site. The construction site can be an infrastructure construction site.

The surface of the area can depend, particularly on the structure to be built: In case of a solar farm, the area may have dimensions of about 2 km×2 km, in case of a highway, the area may have dimensions of 10 km×100 m. However, other areas may have other dimensions, e.g. a building in an area of 300×300 m, or an area comprising still different dimensions.

FIG. 1b further shows a portion of a digital elevation model DEM generated based on data provided by the aerial vehicle. The digital elevation model DEM comprises height information for points of the area 10. Thus, it can be interpreted as 3D-map.

The part of the digital elevation model shown in FIG. 1b corresponds to the line A-A indicated in the orthophoto map O. For each pixel of the line, the digital elevation model comprises a height information.

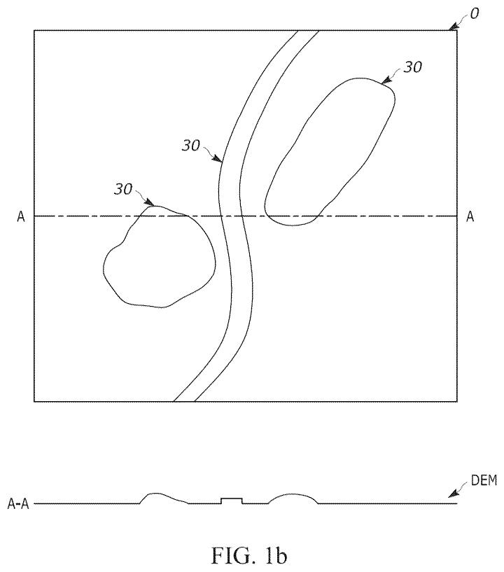

FIG. 2 shows classes assigned to parts 30 of the area 10. In the example of FIG. 2, an ID-variable comprises the class information. As can be seen in FIG. 2, generally, the classes may correspond to the class of the feature corresponding to the respective part 30. In the example of FIG. 2, there is a heap of sand (ID 3), asphalt (ID2) and a heap of earth (ID 3).

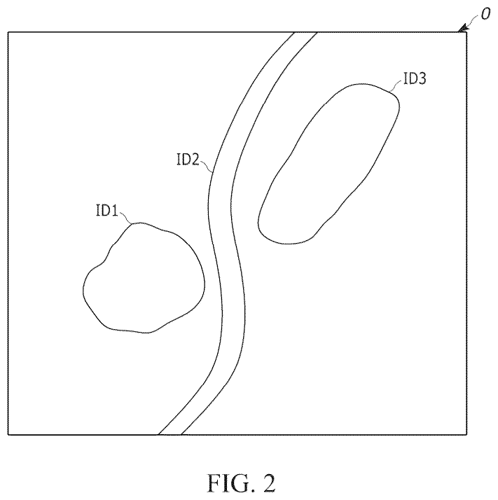

FIG. 3 shows again the orthophoto map O of the area 10.

In the orthophoto map O, polygons 40 approximating the parts 30 are shown. The polygons 40 may for example delimit the parts 30. However, there may also be a plurality of polygons approximating each part, e.g., in a case where the polygons are triangles. Each polygon comprises a plurality of vertexes 45.

The polygons 40 may be 2-dimensional. For example, for the purpose of semantic segmentation, the parts 30 of the area 10 may be approximated by polygons 40 that are indicated by x/y-coordinates of the orthophoto map (or by other two-dimensional coordinates of the orthophoto map).

However, the polygons 40 may also be 3-dimensional, e.g., the vertices may comprise x/y/z-coordinates. Also, the polygons 40 may be 2-dimensional at one point and may be converted to 3-dimensions, e.g., by assigning a third coordinates to the vertices (45).

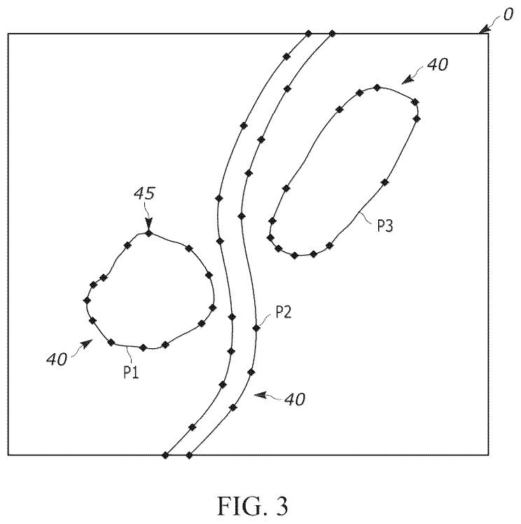

FIG. 4 shows the orthophoto map O and the digital elevation model DEM. FIG. 4 further shows reference surfaces 50 (indicated by the dashed lines in the DEM). In the example of FIG. 4, the reference surfaces are plane surfaces, however, they can also have another shape, such as a more complex shape.

The reference surfaces 50 may approximate lower ends of at least some of the objects corresponding to the parts 40. For example, in case of heaps of material, e.g., sand or earth, the lower end may be a ground surface on which the material was dumped or heaped up.

The vertexes 45 of at least some or all of the polygons 40 may lie in the corresponding reference surface 50 at one point of the method. For example, the polygons 40 may be generated as 2-dimensional polygons, that are then projected on the reference surface 50, further comprising assigning corresponding elevation coordinates to the vertexes 45.

In another example, the vertexes 45 of the polygons 40 comprise already elevation coordinates, that are then adapted. For example, a median, an average or another estimation of the elevation coordinates of the vertexes 45 a polygon 40 may then be assigned to these vertexes 45. The reference surface 50 may then be a horizontal plane, i.e., a plane of constant elevation, at the elevation of the vertexes.

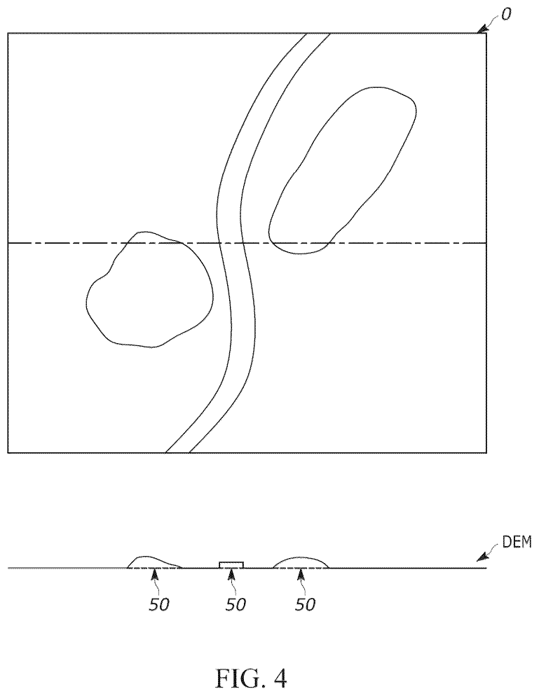

FIG. 5 shows the orthophoto map O and the digital elevation model DEM. FIG. 5 further shows volumes 60 of the parts 30. In FIG. 5, the volumes are indicated by hatching in the DEM. The volumes may be determined based on the polygons 40, the reference surfaces 50 and the digital elevation model DEM. The volumes 60 may be indicated by scalar values, e.g., 600 m³ or, e.g., in case of a known or estimated material, 500 t. The volumes 60 may however also be indicated by shapes, e.g., as 3D-polygons, geometric shapes, vector data, as voxel or by another representation.

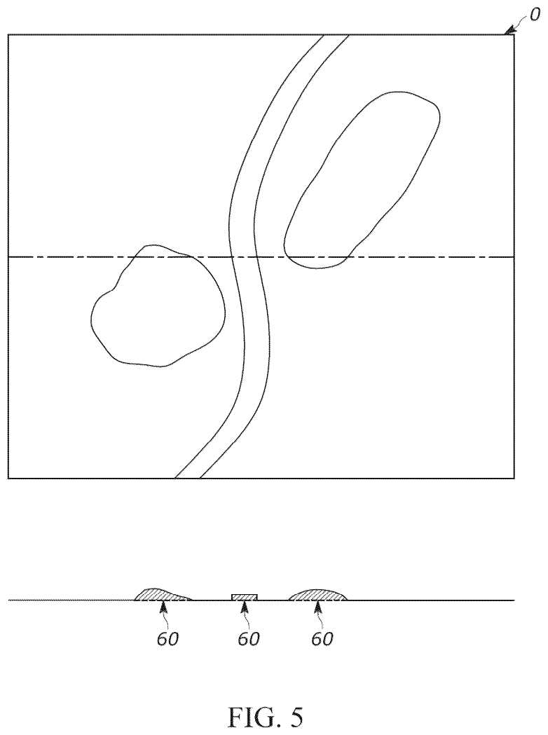

FIG. 6 shows a polygon 40. In the example, the polygon comprises 6 vertexes.

As can be seen, the polygon has been converted: An initial version is indicated by a dashed line, a converted or processed version is indicated by a solid line.

The converted or processed version of the polygon 40 may still comprise a same number of vertexes 45, however, their elevation coordinates may be changed.

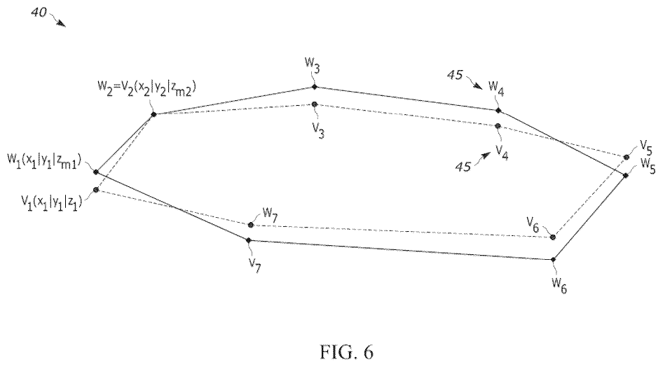

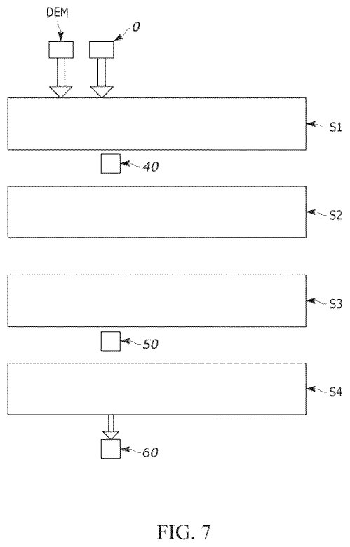

FIG. 7 shows a method. A system can be configured for performing the method.

The method in FIG. 7 comprises a processing step S1, a determining at least one feature step S2, classifying feature step S3 and a communication initiating step S4.

The method may comprise processing the orthophoto map O and the digital elevation model DEM. In the feature determining step, the polygons 40 approximating the parts 30 of the area 10 may be generated. The classifying feature step may be performed by means of a convolutional neural network. A system may be configured for performing the steps.

The feature determining step may comprise assigning a class to each portion of the orthophoto map O.

### Exemplary Classes May Comprise:

background, i.e. no object of interest,
asphalt,
concrete foundation,
concrete ring,
pipe,
tree,
black or dark sand,
cable well,
cars,
chipping,
container,
dump truck,
heap of earth,
heart of sand,
heavy earth equipment,
lantern,
people,
reinforcement,
rubble,
scaffolding,
silo,
water,
wooden boards,
fence,
pavement,
crushed stone for railways, e.g. for track ballast,
concrete grid,
paving blocks,
aggregate, e.g. for generation of electricity or compressed air,
geotextile,
sheet piling, such as Larssen sheet piling,
artificial rocks,
formwork,
retaining wall,
crane,
steel structure,
wall,
roof, and
floor.

The person skilled in the art will easily understand that, instead of assigning the class “background” to a portion, the method may also comprise not assigning a class to said portion or assigning a “null”-class to a portion.

An input for the convolutional neural network may be image data from the orthophoto map O, e.g. grey scale data or RBG-channel data. A further input for the convolutional neural network may be data from the digital elevation model DEM. For example, elevation data or data derived thereof, such as a gradient of the elevation, a difference quotient or a difference of elevation at neighbouring pixels may be used as input data for the convolutional neural network.

The feature determining step may comprise for at least some of the polygons 40 determining volumes between a portion of the digital elevation model DEM and a corresponding portion of the respective reference surface 50.

For example, the feature determining step may comprise for the at least some polygons 40 generating a geometric solid of the part 30 approximated by the respective polygon 40.

However, the feature determining step may also just comprise determining a scalar feature, such as volume corresponding to the part 30 approximated by the respective polygon 40, e.g. by integrating over an elevation difference within the polygon 40 according to the following equation 1.

Below, Equation 1 is provided as an exemplary part of the volume determining step. Equation 1 is to be applied under the assumption that a reference surface 50 and the digital elevation model DEM within a polygon 40 are non-intersecting. In the opposite case, the equation has to be applied separately for parts of the polygon delimited by intersections between the DEM and the reference surface within the polygon.

$$V = \vert {\int }_{{y}_{P o l}} {\int }_{{x}_{P o l} ( {y}_{P o l} )} ( {z}_{D E M} ( x , y ) - {z}_{r e f} ( x , y ) ) dxdy \vert \qquad Eq . 1$$

In Equation 1, “Polygon” refers to the x- and y-coordinates of the surface within the polygon. z_{DEM} refers to the elevation or z-coordinate indicated by the digital elevation model DEM at the coordinates x, y. z_{ref} refers to the elevation of the reference surface 50 at the coordinates x, y. x_{Pol}(y) refers to the x-coordinates of the points within the polygon at an indicated y-coordinate. yₚₒₗ refers to the y-coordinates of the points within the polygon.

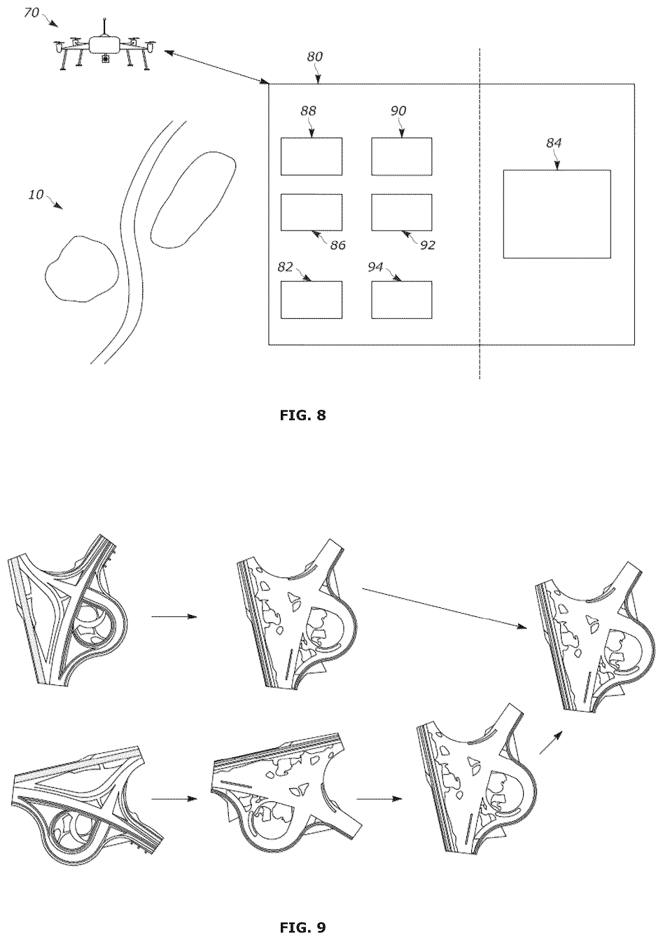

A further embodiment of the method is shown in FIG. 9. With respect to the embodiment of FIG. 7, the method further comprises a data comparison step S5.

The method in FIG. 9 further comprises receiving feature data 20. The feature data in FIG. 9 relate to the area 10. The feature data 20 may for example be data in a CAD-format, such as the Drawing Interchange File Format (.dxf) format of Autodesk, Inc., San Rafael, CA, USA, or the DGN format, supported by MicroStation software of Bentley Systems Incorporated, Exton, PA, USA.

The feature data 20 comprise information relating to objects that are to be constructed or to be present in the area 10. These feature data 20 can for example be georeferenced, i.e. they may comprise an indication of the geographic locations of the objects specified by the design data 20.

Further, the method may comprise determining geographical positions of the vertexes 45 of the polygons 40 generated based on the orthophoto map O and/or the digital elevation model DEM. Hence, geographic locations of the feature 60 may be determined.

The data comparison step in FIG. 9 comprises comparing the feature 60 identified in the area 10 and the feature specified in the feature data 20.

This allows to identify deviations between the features specified by the feature data 20 and the parts identified in the area 10.

Thus, optionally advantageously, deviations of positions can be determined.

Further, a progress of a construction site or other earth movement in the area 10 can be determined.

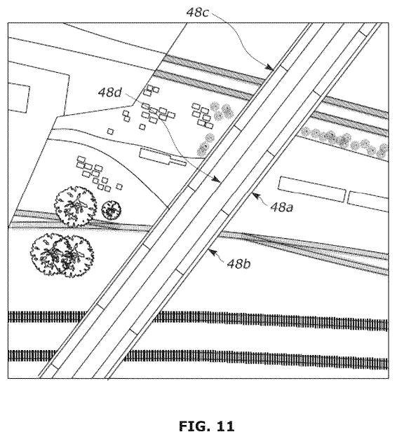

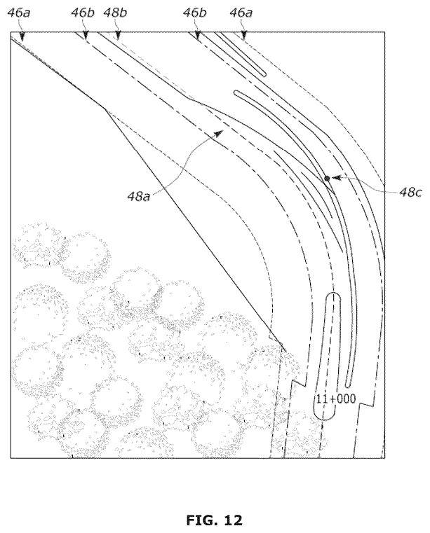

FIG. 11 shows different rotations of a section of an orthophoto map. As can be seen, the sections can be rotated e.g. once or several times around 90 degrees. The section can be inputted to the segmentation component/the segmentation step in each generated orientation. For the results, the rotation may then be reversed and the results of the different rotations may be merged. This may be optionally advantageous so as to provide more analysable input data to the data processing component, particularly to the convolutional neural network. Thus, more parts of the area may be correctly determined.

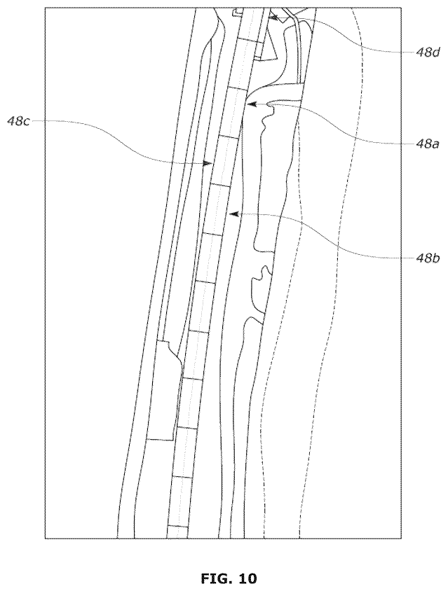

FIG. 10 shows a system. The system may be configured for performing the method.

The system comprises a data processing component 80.

The data processing component 80 may comprise one or more processing units configured to carry out computer instructions of a program (i.e. machine readable and executable instructions). The processing unit(s) may be singular or plural. For example, the data processing component 80 may comprise at least one of CPU, GPU, DSP, APU, ASIC, ASIP or FPGA.

The data processing component 80 may comprise memory components, such as the data storage component 82. The data storage component 82 as well as the data processing component 80 may comprise at least one of main memory (e.g. RAM), cache memory (e.g. SRAM) and/or secondary memory (e.g. HDD, SDD).

The data processing component 80 may comprise volatile and/or non-volatile memory such an SDRAM, DRAM, SRAM, Flash Memory, MRAM, F-RAM, or P-RAM. The data processing component 80 may comprise internal communication interfaces (e.g. busses) configured to facilitate electronic data exchange between components of the data processing component 80, such as, the communication between the memory components and the processing components.

The data processing component 80 may comprise external communication interfaces configured to facilitate electronic data exchange between the data processing component and devices or networks external to the data processing component, e.g. for receiving data from the unmanned aerial vehicle 70.

For example, the data processing component may comprise network interface card(s) that may be configured to connect the data processing component to a network, such as, to the Internet. The data processing component may be configured to transfer electronic data using a standardized communication protocol. The data processing component may be a centralized or distributed computing system.

The data processing component may comprise user interfaces, such as an output user interface and/or an input user interface. For example, the output user interface may comprise screens and/or monitors configured to display visual data (e.g. an orthophoto map (O) of the area 10) or speakers configured to communicate audio data (e.g. playing audio data to the user). The input user interface may e.g. a keyboard configured to allow the insertion of text and/or other keyboard commands (e.g. allowing the user to enter instructions to the unmanned aerial vehicle or parameters for the method) and/or a trackpad, mouse, touchscreen and/or joystick, e.g. configured for navigating the orthophoto map O or objects identified in the orthophoto map.

To put it simply, the data processing component 80 may be a processing unit configured to carry out instructions of a program. The data processing component 80 may be a system-on-chip comprising processing units, memory components and busses. The data processing component 80 may be a personal computer, a laptop, a pocket computer, a smartphone, a tablet computer. The data processing component may comprise a server, a server system, a portion of a cloud computing system or a system emulating a server, such as a server system with an appropriate software for running a virtual machine. The data processing component may be a processing unit or a system-on-chip that may be interfaced with a personal computer, a laptop, a pocket computer, a smartphone, a tablet computer and/or user interfaces (such as the upper-mentioned user interfaces).

In the example of FIG. 10, the data-processing component comprises a portion located in a cloud system (the segmentation component 84 comprising the convolutional neural network—shown on the right of the dashed line in FIG. 10) and a portion located on a computer system, such as a server (shown on the left of the dashed line in FIG. 10). This may be optionally advantageous, as training and evaluating a neural network may be particularly demanding in terms of computing power. This computing power may be provided efficiently by means of a cloud-computing system.

In the example of FIG. 10, the data-processing component comprises a analysing component 84 configured for performing the initiating communication.

In other words, the data processing component 80 may comprise an analyzing component 84. More particularly, the data processing component 80 may comprise at least one storage device wherein the data processing component 80 may be stored.

The analyzing component 84 may be implemented in software. Thus, the segmentation component 84 may be a software component, or at least a portion of one or more software components. The data processing component 80 may be configured for running said software component, and/or for running a software comprising this software component. In other words, the segmentation component 84 may comprise one or more computer instructions (i.e. machine-readable instructions) which may be executed by a computer (e.g. the data processing component 80).

The analyzing component 84 may be stored on one or more different storage devices. For example, the segmentation component 84 may be stored on a plurality of storage components comprising persistent memory, for example a plurality of storage devices in a RAID-system, or different types of memory, such as persistent memory (e.g. HDD, SDD, flash memory) and main memory (e.g. RAM).

The analyzing component 84 may also be implemented at least partially in hardware. For example, the analyzing component 84 or at least a portion of the analysing component 84 may be implemented as a programmed and/or customized processing unit, hardware accelerator, or a system-on-chip that may be interfaced with the data processing component 80, a personal computer, a laptop, a pocket computer, a smartphone, a tablet computer and/or a server.

The analyzing component 84 may also comprise elements implemented in hardware and elements implemented in software. An example may be a use of a hardware-implemented encryption/decryption unit and a software implemented processing of the decrypted data.

The analyzing component 84 may comprise elements specific to the data processing system 80, for example relating to an operating system, other components of the data processing system 80, or the unmanned aerial vehicle 70 to which the data processing system 80 may be connected.

Further, data processing system 80 may comprise a feature determining component 86. The feature determining component may be configured for performing the projection step and the reference surface generation step. More particularly, the data processing system 80 may comprise at least one storage device wherein the feature determining component 86 may be stored.

The data processing system 80 may comprise a volume determining component 88. The volume determining component 88 may be configured for performing the volume determining step.

Also, the data processing system 80 may comprise a pre-processing component 90. The pre-processing component 90 may be configured for performing the pre-processing step.

The data processing system 80 may comprise a post-processing component 92. The post-processing component 92 may be configured for performing the post-processing step.

Further, the data processing system 80 may comprise an area-comparison component 94. The area-comparison component 94 may be configured for performing the data comparison step.

The data processing system 80 may comprise at least one storage device wherein at least one of the features determining component 86, the volume determining component 88, the pre-processing component 90, the post-processing component 92 and the area-comparison component 94 may be stored, such as the data-storage component 82.

At least one of the features determining component 86, the volume determining component 88, the pre-processing component 90, the post-processing component 92 and the area-comparison component 94 may be implemented in software. One, some or all of these components may be a software component, or at least a portion of one or more software components. The data processing system 80 may be configured for running said software components, and/or for running a software comprising the software components. In other words, the components may comprise one or more computer instructions (i.e. machine readable instructions) which may be executed by a computer (e.g. the data processing system 80).

At least one of the features determining component 86, the volume determining component 88, the pre-processing component 90, the post-processing component 92 and the area-comparison component 94 may be stored on one or more different storage devices. For example, the at least one of the components may be stored on a plurality of storage components comprising persistent memory, for example a plurality of storage devices in a RAID-system, or different types of memory, such as persistent memory (e.g. HDD, SDD, flash memory) and main memory (e.g. RAM).

The components may also be implemented at least partially in hardware. For example, at least one of the feature determining component 86, the volume determining component 88, the pre-processing component 90, the post-processing component 92 and the area-comparison component 94 or at a part of one of their functionalities may be implemented as a programmed and/or customized processing unit, hardware accelerator, or a system-on-chip that may be interfaced with the data processing system 80, a personal computer, a laptop, a pocket computer, a smartphone, a tablet computer and/or a server.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

### REFERENCE SIGNS

O orthophoto map
O1 first orthophoto map
O2 second orthophoto map
DEM digital elevation model
DEM1 first digital elevation model
DEM2 second digital elevation model
10 area
20 design data
30 part
40 polygon
45 vertex of the polygon
50 reference surface
60 volume
70 unmanned aerial vehicle
80 data-processing system
82 data-storage component
84 analysing component
86 feature determining component
88 volume determining component
90 pre-processing component
92 post-processing component
94 area-comparison component
S1 Analyzing step
S2 Projection step
S3 feature data generation step
S4 feature determining step
S5 Data comparison step
S6 feature comparison step

1-15. (canceled)

16. A system for analysing progress on at least one construction site, wherein the system comprising:
at least one data processing component configured to process at least one input orthophoto map of an area,
at least one feature determining component configured to determine feature data of the at least one input orthophoto map,
at least one analysing component configured to initiate at least one communication based on at least the determined feature data.

17. The system according to claim 16 wherein the data processing component is further configured to generate at least one or a plurality of polygon(s) based on the input orthophoto map, each polygon approximating a part of the input orthophoto map.

18. The system according to claim 17 wherein the system is configured to determine the feature data by projecting the polygon(s) on the input orthophoto map.

19. The system according to claim 16 wherein the system particularly the feature determining component is configured for determining the feature data of the input orthophoto map by means of at least one convolutional neural network, wherein the feature data comprises at least one coordinate-based representation of at least one surface.

20. The system according to claim 16 wherein the feature determining component is further configured to determine a change in a feature over a pre-determined time interval in at least two input orthophoto maps, wherein the change in feature comprises absence of a coordinate and/or pixel and/or polygon, addition of at least one coordinate and/or pixel and/or polygon.

21. The system according to claim 20 wherein the system, particularly the analysing component is configured to determine at least one stage based on the determined change in feature.

22. The system according to claim 21 wherein the analysing component comprises at least one schedule data based on the at least one stage.

23. The system according to claim 22 wherein the analysing component is configured to deploy at least one transaction protocol, such as a smart contract, based on at least one parameter based on the stage.

24. The system according to claim 23 wherein the transaction protocol is configured to be executed based on a schedule model, wherein the schedule model is configured to be generated based on schedule data.

25. The system according to claim 24 wherein the system, particularly the analysing component is configured for enabling the communication between at least two nodes based on the schedule model.

26. The system according to claim 25 wherein the system, particularly the analysing component is configured for enabling the communication between the two nodes when a pre-determined condition is met, wherein the pre-determined condition comprises a pre-determined stage.

27. The system according to claim 24, wherein the schedule model is configured to be generated based on the feature data.

28. The system according to claim 16 wherein the system is a system configured for analysis of aerial images.

29. The system according to claim 28 wherein the data-processing component is configured for receiving at least one of image data and elevation data from an aerial vehicle and/or a satellite.

30. The system according to claim 16 wherein the area comprises a construction site.

31. A method, comprising:
processing at least one input orthophoto map of an area,
determining feature data of at least one input orthophoto map,
initiating at least one communication based on at least the determined feature data.

32. The method according to claim 16 comprising determining a change in a feature over a pre-determined time interval in at least two input orthophoto maps.

33. The method according to claim 16 comprising determining at least one feature difference between at least two assigned classes of the orthophoto map and/or feature data taken at least two different times.

34. A computer program product comprising instructions which, when the program is executed by a computer, cause the computer to:
process at least one input orthophoto map of an area,
determine feature data of at least one input orthophoto map,
initiate at least one communication based on at least the determined feature data.

35. The computer program product according to claim 34 further comprising instructions which, when executed by a computer, cause the computer to determine a change in a feature over a pre-determined time interval in at least two input orthophoto maps.
